(19) United States
(12) Patent Application Publication
(10) Pub. No.: US 2012/0117464 A1
(43) Pub. Date: May 10, 2012

(54) Document Processing System

(75) Inventors: Minoru Koshimizu, Kanagawa (JP); Naoki Hayashi, Kanagawa (JP); Hiroyuki Hotta, Kanagawa (JP); Yoshitsugu Hirose, Kanagawa (JP)

(73) Assignee: FUJI XEROX CO., LTD., Tokyo (JP)

(21) Appl. No.: 13/350,400

(22) Filed: Jan. 13, 2012

Related U.S. Application Data
(62) Division of application No. 11/272,716, filed on Nov. 15, 2005.

(30) Foreign Application Priority Data
Apr. 25, 2005 (JP) 2005-126258

(51) Int. Cl. G06F 17/00

(52) U.S. Cl. 715/255

(57) ABSTRACT

A document display device for displaying a document on a screen on the basis of document information, includes: a sensor for detecting an action made on the document display device; a document information storing means for holding the document information of documents to be displayed on the screen; and a correspondence information processing means for storing information of an action detected by the sensor in a state that a document is displayed on the screen in such a manner that it is correlated with document information of the document being displayed on the screen.

This is a Divisional of U.S. patent application Ser. No. 11/272,716 filed Nov. 15, 2005. The disclosure of this prior application is incorporated herein by reference in its entirety.

### BACKGROUND OF THE INVENTION

1. Field of the Invention

The present invention relates to a technique that manages electronic data (document information, document images, or the like) of documents to be displayed on a document display unit such as a document display device and information of actions that were made on the document display body in such a manner that they are correlated with each other, and that makes it possible to display-output a corresponding document when an action is made on the document display unit.

2. Background Art

With the development of the computer technologies, documents have come to be generated by using various kinds of medium data such as characters, figures, and images. Document information (electronic data) thus formed is displayed on the screen of a display device or printed on sheets for reading by users.

As described above, document information has advantages that it can be generated easily and can be stored and held compactly in a memory as electronic data. On the other hand, it is difficult for a user to immediately judge the content of a document from its document information and to select document information of a desired document from a large number of document information and immediately read it.

A technique that is employed to facilitate work of selecting document information of a desired document from a large number of document information is to add, to each piece of document information, attribute information that is text information consisting of a document name, a person who generated the document, an update date and time, etc. A user can select a desired document by referring to attribute information and can read it.

However, the method of adding attribute information to each piece of document information requires a user to do complicated setting work such as explicitly inputting attribute information (text information) using a pen device, a keyboard, or the like or selecting items from menus.

An invention is known that makes it possible to display the whole of a large display subject on the screen, having a limited size, of an image display device. In this invention, an image display device is equipped with an acceleration sensor and a display subject being displayed on the screen of the image display device is translated or contracted/enlarged in accordance with a parallel movement or a rotation detected by the acceleration sensor (JP-A-2004-271571).

Another invention is known that makes it possible to display a three-dimensional display subject from different viewing points using the screen of an image display device. In this invention, an image display device is equipped with a sensor for detecting a movement and the position from which a display subject is projected on the screen of the image display device is changed in accordance with an action detected by the sensor (JP-A-2004-309947).

A further invention is known that allows a cell phone to display information corresponding to information of a location where the cell phone exists by causing a server to provide the cell phone with map information in accordance with the location information (JP-A-2004-363741).

As described above, it is now required to manage document information so as to allow a user to easily select a desired piece of document information. It is also required to allow a user to easily read a document on the basis of a desired piece of document information.

The inventions described in JP-A-2004-271671, JP-A-2004-309947 and JP-A-2004-363741 are such that a movement of a device is detected and the display range of the same display subject is changed, and hence are entirely different from the concepts of managing a large number of document information and selecting and displaying a desired piece of document information.

### SUMMARY OF THE INVENTION

The present invention has been made in view of the above circumstances in the art, and an object of the invention is to manage document information using, as keys, actions that were made by a user on a document display unit (document display device).

The present invention has been made in view of the above circumstances in the art, and another object of the invention is to allow a user to read a desired document using, as a key, an action that is made by the user on a document display unit (document display device).

The present invention has been made in view of the above circumstances in the art, and still another object of the invention is to manage document information without requiring complicated manipulation work so that a user can easily select a desired piece of document information.

The present invention has been made in view of the above circumstances in the art, and yet another object of the invention is to allow a user to read a desired document without the need for doing complicated manipulation work.

The present invention has been made in view of the above circumstances in the art, and a further object of the invention is to make it unnecessary to make manipulations for input of text information (a document name, a person who generated the document, an update date and time, etc.) that explicitly indicates a document, that is, to make it possible to detect an action made on a document display unit and correlate information of the action with document information and to allow a user to easily call and read a document that is correlated with information of an action by making the action on the document display unit.

To attain the above objects, the invention is implemented in various forms such as a document display device, a document processing system, a document processing method, and a document processing program.

In a document display device (refer to the embodiment of FIG. 2) according to one aspect of the invention, the document display device for displaying a document on a screen on the basis of document information comprises a sensor for detecting an action made on the document display device itself and stores information of an action detected by the sensor in a state that a document is displayed on the screen in such a manner that it is correlated with document information of the document being displayed on the screen.

With this configuration, when a user merely makes an action on the document display device as a simple manipulation such as hitting, swinging or rotation, information of the action and document information of a document being displayed on the screen come to be managed so as to be correlated with each other. This makes it possible to call the document information using this action (manipulation) as a key.

In a document display device (refer to the embodiment of FIG. 2) according to another aspect of the invention, the document display device for displaying a document on a screen on the basis of document information comprises a sensor for detecting an action made on the document display device itself and correspondence information that correlates action information with respective the document information. The document display device retrieves document information corresponding to information of an action detected by the sensor by referring to the correspondence information, and displays a document on the screen on the basis of the retrieved document information.

With this configuration, when a user merely makes an action on the document display device as a simple manipulation as mentioned above, document information that is correlated with information of the action is called and displayed on the screen.

A document processing system (refer to the embodiment of FIG. 8) according to another aspect of the invention may employ, as a document display unit, a printed sheet on which a document image is printed as well as a document display device having a function of generating a document image on the basis of document information (electronic data) and continuing to display it on a screen or a function of continuing to display a document image on a screen on the basis of the document image (electronic data). In the document processing system according to this aspect, a sensor provided in the document display device or a sensor (e.g., an action detection sensor device that is a camera) that is set separately from the document display device or the printed sheet so as to be able to detect its movement detects an action made on the document display unit that continues to display a document image, and transmits information of the action. A server receives the information of the action detected by the sensor, and stores the received action information in such a manner that it is correlated with document information of the document image continuing to be displayed on the document display unit.

With this configuration, when a user merely makes an action on the document display device or printed sheet as a simple manipulation as mentioned above, information of the action and document information of a document continuing to be displayed come to be managed by the server so as to be correlated with each other. This makes it possible to call the document information using this action (manipulation) as a key.

It is preferable that the document display device be a flexible, thin electronic paper having a display section for continuing to display a document image in a state that it is not supplied with electric power.

In a document processing system (refer to the embodiment of FIG. 8) according to another aspect of the invention, a sensor provided in a document display device or a sensor (e.g. an action detection sensor device that is a camera) that is set separately from a document display device or a printed sheet so as to be able to detect its movement detects an action made on the document display unit that continues to display a document image, and transmits information of the action. A server receives the information of the action detected by the sensor, and retrieves document information corresponding to the received action information by referring to correspondence information that correlates action information with respective the document information.

With this configuration, when a user merely makes an action on the document display device as a simple manipulation as mentioned above, document information that is correlated with information of the action is called, which allows the document concerned to be displayed on the screen or print-output.

A document processing system (refer to the embodiment of FIG. 6) according to still another aspect of the invention has a document display device for displaying a document image on a screen on the basis of document information and a server for managing the document information, and is of a thin client type in which a document image (electronic data) is supplied from the server to the document display device. In the document processing system according to this aspect, the document display device displays a document image received from the server, detects, with a sensor, an action made on the document display device itself in a state that the document image is displayed on the screen, and transmits information of the detected action to the server. The server stores the action information received from the document display device in such a manner that it is correlated with document information of the document image being displayed on the screen of the document display device.

With this configuration, when a user merely makes an action on the document display device as a simple manipulation as mentioned above, information of the action and document information of a document continuing to be displayed come to be managed by the server so as to be correlated with each other. This makes it possible to acquire a corresponding document image from the server by calling the document information using this action (manipulation) as a key, and to display it on the screen.

A document processing system (refer to the embodiment of FIG. 6) according to another aspect of the invention has a document display device for displaying a document image on a screen on the basis of document information and a server for managing the document information. A document image is supplied from the server to the document display device. In the document processing system according to this aspect, the document display device detects, with a sensor, an action made on the document display device itself and transmits information of the detected action to the server. The server retrieves document information corresponding to the action information received from the document display device by referring to correspondence information that correlates the action information with respective the document information, generates a document image on the basis of the retrieved document information, and transmits the generated document image to the document display device. The document display device displays the document image received from the server on the screen.

With this configuration, when a user merely makes an action on the document display device as a simple manipulation as mentioned above, document information that is correlated with information of the action can be acquired from the server and displayed on the screen.

A document processing system (refer to the embodiment of FIG. 7) according to yet another aspect of the invention has a document display device for displaying a document image on a screen on the basis of document information and a server for managing the document information. The document display device generates a document image on the basis of document information supplied from the server and displays the generated document image on the screen. In the document processing system according to this aspect, the document display device detects, with a sensor, an action made on the document display device itself in a state that a document image is displayed on the screen on the basis of document information, and transmits, to the server, information of the detected action and identification information of the document information. The server stores the action information received from the document display device in such a manner that it is correlated with document information of the document image being displayed on the screen of the document display device.

With this configuration, when a user merely makes an action on the document display device as a simple manipulation as mentioned above, information of the action and identification information of a document continuing to be displayed are transmitted to the server and come to be managed by the server so as to be correlated with corresponding document information. This makes it possible to acquire the document information from the server by calling the document information using this action (manipulation) as a key, and to display a corresponding document image on the screen.

A document processing system (refer to the embodiment of FIG. 7) according to a further aspect of the invention has a document display device for displaying a document image on a screen on the basis of document information and a server for managing document information. The document display device generates a document image on the basis of document information supplied from the server and displays the generated document image on the screen. In the document processing system according to this aspect, the document display device detects, with a sensor, an action made on the document display device itself, transmits information of the detected action to the server. The server retrieves document information corresponding to the action information received from the document display device by referring to correspondence information that correlates the action information with respective the document information, and transmits the retrieved document information to the document display device. The document display device displays a document image on the basis of the document information received from the server on the screen.

with this configuration, when a user merely makes an action on the document display device as a simple manipulation as mentioned above, document information that is correlated with information of the action can be acquired from the server and a document image generated on the basis of the document image can be displayed on the screen.

In the invention, user identification information that is input through user information input means and/or location information that is input through the location information input means may be stored and managed together with action information so as to be correlated with document information and used as a key (s) for calling a corresponding document.

With this measure, for example, if identification information of a user of the document display device is input by a key manipulation or fingerprint authentication, corresponding document information can be managed or called by using the action information and the user identification information as AND-condition keys. Likewise, if information of a location where the document display device exists is input by a key manipulation or acquisition through the GPS system, corresponding document information can be managed or called by using the action information and the location information as AND-condition keys. These make it possible to manage document information and display it on the screen according to the user or the location where the document display device is used.

According to the invention, document information can be correlated with an action to be made on the document display device and can thereby be managed and called (and output) without the need for making manipulations for input of text information (a document name, a person who generated the document, an update date and time, etc.) that explicitly indicates a document. This makes it possible to realize an intuitive manipulation environment for electronic documents in which a user's action (swinging, hitting, placement, or the like) is employed as a manipulation.

### BRIEF DESCRIPTION OF THE DRAWINGS

These and other objects and advantages of this invention will become more fully apparent from the following detailed description taken with the accompanying drawings in which:

FIG. 1 shows how a document display device according to the embodiment of the invention operates;

FIG. 2 shows the functional configuration of the document display device according to the embodiment of the invention;

FIGS. 3A to 3C show actions made on the document display device;

FIG. 4 shows detected action information;

FIG. 5 shows detected action information;

FIG. 6 shows the functional configuration of a document processing system according to another embodiment of the invention;

FIG. 7 shows the functional configuration of a document processing system according to still another embodiment of the invention;

FIG. 8 shows the functional configuration of a document processing system according to a further embodiment of the invention;

FIGS. 9A and 9B show an exemplary electronic paper; and

FIG. 10 shows the principle of operation of the exemplary electronic paper.

### DETAILED DESCRIPTION OF THE PREFERRED EMBODIMENTS

The present invention will be hereinafter described in a specific manner using embodiments.

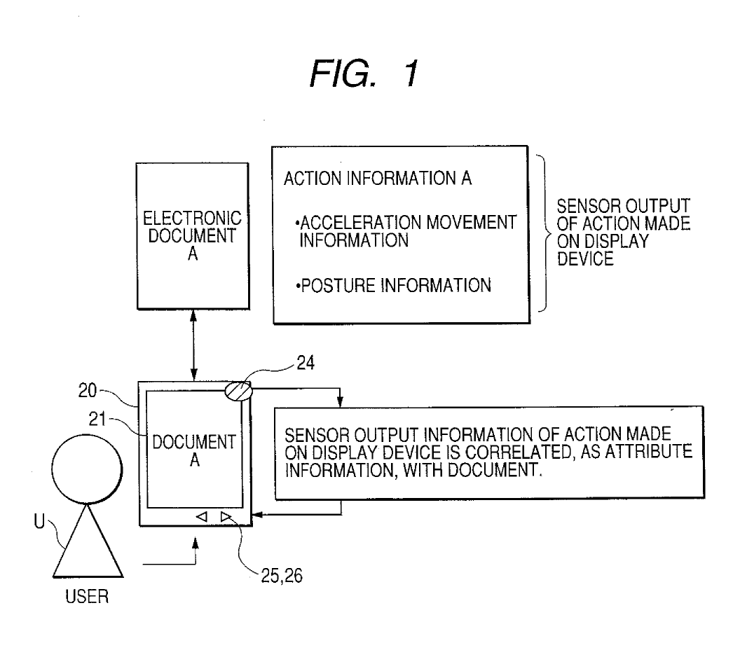

FIGS. 1-5 show an embodiment in which the invention is implemented as a document display device which displays a document on the screen on the basis of document information.

The document display device according to this embodiment is a portable computer having computer hardware (e.g., a computer having a display screen such as a PDA). And functions (described later) according to the invention are realized in such a manner that the computer hardware runs programs relating to the invention, the functions being a function of detecting an action that is made on the document display device in a state that a document is displayed on the screen and storing information of the action in such a manner that it is correlated with document information of the document being displayed on the screen, a function of detecting an action made on the document display device and retrieving document information corresponding to information of the detected action from the document information storing means by referring to correspondence information that correlates the document information and action information, and a function of displaying a document on the screen on the basis of retrieved document information.

An electronic paper which is thin and flexible like a sheet will be described below as a preferable example of a device capable of being used as the document display device.

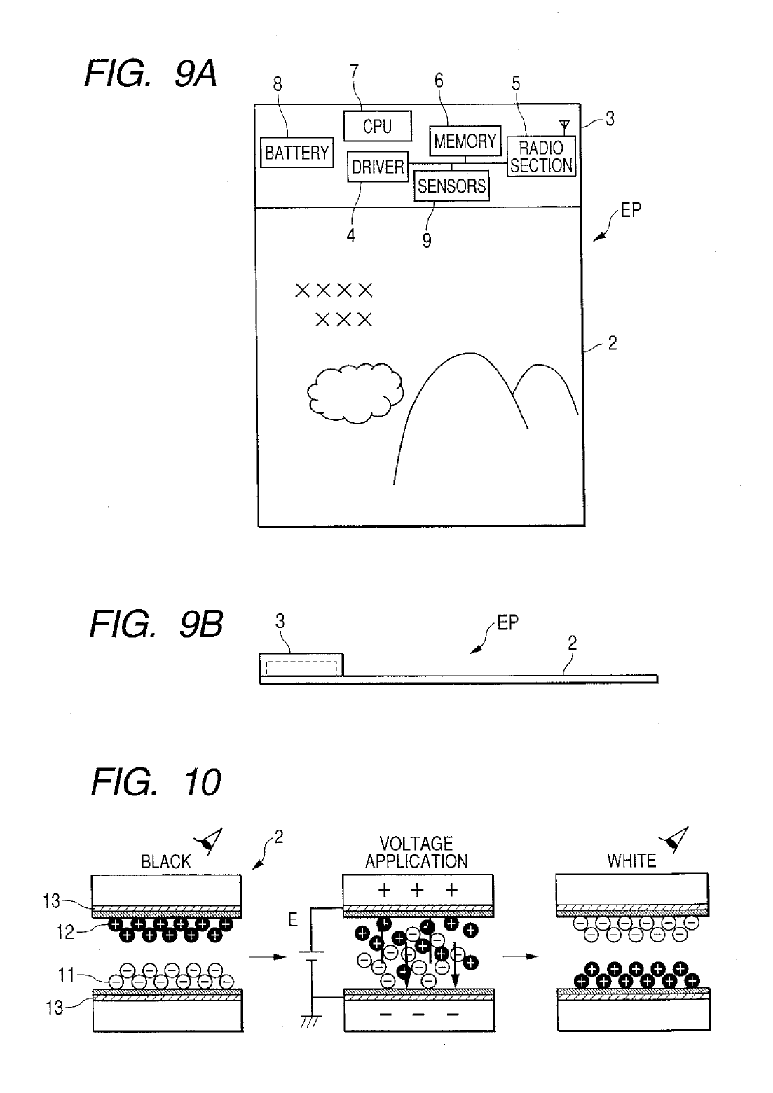

FIGS. 9A and 9B are a front view and a side view of an electronic paper EP, respectively. The illustrated electronic paper EP has a display section 2 for continuing to display a document image and a processing section 3 for processing electronic data. FIG. 9A also shows various functional sections that are incorporated in the processing section 3.

The electronic paper EP is a flexible, thin display recording device the size of the A4 sheet, for example. The processing section 3 is disposed on one side of the display section 2 which occupies most of the entire area.

The size of the display section 2 is set according to the purpose. The display section 2 and the processing section 3 may be detachable from each other. For example, the electronic paper EP may be constructed by attaching and connecting a clip-like processing section 3 to the display section 2.

The processing section 3 is equipped with a driver 4 for driving the display section 2, a radio section (communication means) 5 for performing a radio communication with the outside, a readable and writable memory 6 for holding electronic data such as document information, a controller (CPU) 7 for performing prescribed processing according to programs, a battery 8 for supplying operation power to functional means such as the controller 7, and sensors 9 for detecting an action (hitting, swinging, or the like) made on the electronic paper EP.

The document display device (electronic paper) according to the embodiment described below is equipped with manipulation buttons to be used for receiving, from a user, user identification information (user ID) and information of a position where the document display device exists and means for receiving and acquiring information of a position where the document display device exists from the GPS system or a PHS system.

The sensors 9 may be various sensors corresponding to respective types of actions to be detected. For example, an acceleration sensor can detect strength and a time interval of hits on the electronic paper EP (document display device) as well as strength of moving or swinging on the electronic paper EP (document display device). Plural acceleration sensors that are oriented in 3-axis directions can detect a moving or swinging direction. A pressure sensor as one of the sensors 9 can also detect strength of hitting on the electronic paper EP (document display device). In such a manner, known sensors may be used for various types of actions to be detected. Assuming that the electronic paper EP will have a thin, light, paper-like shape, it is preferable that each of those sensors be combined with a passive wireless sensor that uses a SAW device or the like and can receive electric power and transmit a detected signal to an external transmission/reception device in a non-contact manner.

The electronic paper EP can receive document information (electronic data) as display information by performing a radio communication with an external radio device (not shown) by means of the radio section 5, and can hold plural the document information in the memory 6.

Where a document processing system is to be constructed by the electronic paper EP (document display device) and a server, the electronic paper EP needs to be equipped with the radio section (communication means) 5 to perform an information communication with the server. However, where the electronic paper EP (document display device) completes processing of management or calling and display of document information by itself as in the case of FIGS. 1-5, the radio section (communication means) 5 can be omitted if an interface or the like for input, from the outside, of document information to be held by the memory 6 is provided.

The thus-configured electronic paper EP can display a document image on the display section (screen) 2 on the basis of document information held by the memory 6 by driving the driver 4 under the control of the controller 7, and has a function of continuing to hold, in a displayed state, the document image on the display section 2 even after removal of drive power of the driver 4.

As shown in FIG. 10 which shows the principle of operation of the display section 2 of the electronic paper EP, in a state that no voltage is applied between electrodes 13 (however, the electrodes 13 are changed with polarities of the preceding driving), white particles 11 that are charged negatively (minus) collect on the back surface side whereas black particles 12 that are changed positively (plus) collect on the front surface side, whereby the display section 2 looks black if viewed from the front surface side. If the electrode polarities of prescribed matrix portions are reversed according to image information to be display as the driver 4 operates on the basis of electronic data, the positions of the white particles 11 and the black particles 12 are interchanged there, whereby image information is displayed on the display section 2 by utilizing the contrast between the white particles 11 and the black particles 12. The image information that is displayed on the display section 2 by utilizing the contrast between the white particles 11 and the black particles 12 can be switched by causing the driver 4 to operate on the basis of different electronic data. As such, the electronic paper EP can be used many times.

In addition to the property that it is thin and flexible like a sheet, the electronic paper EP has the property that it can hold image information displayed on the display section 2 without requiring supply of electric power. As such, the electronic paper EP can be used as if it were a sheet.

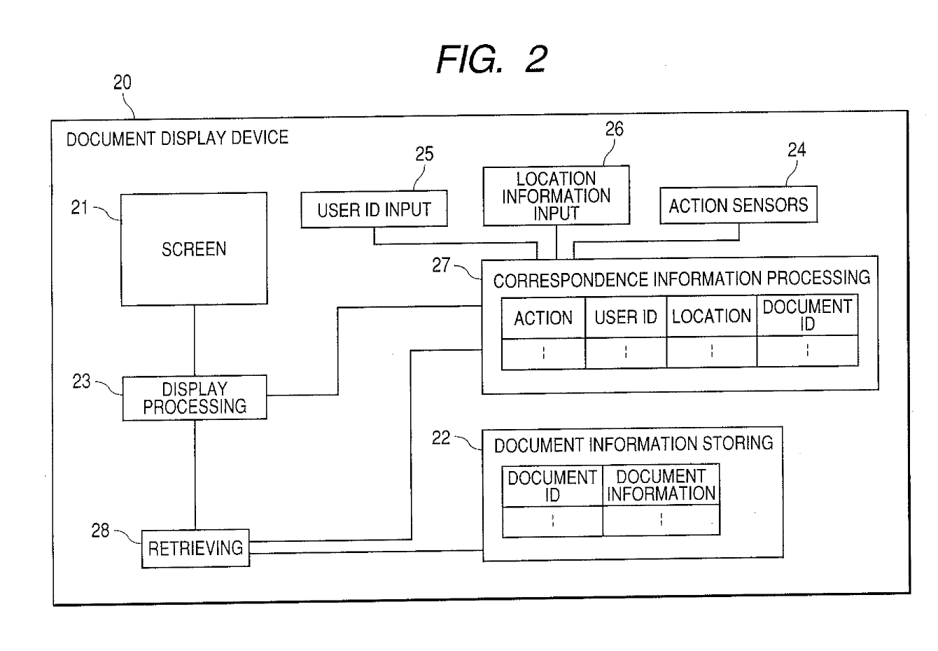

FIG. 2 shows the functional configuration of a document display device 20 using the electronic paper EP or the like.

The document display device 20 is equipped with a screen 21 for displaying a document image, a document information storing means 22 for holding plural the document information (electronic document data) that can be discriminated from each other by respective document IDs, a display processing means 23 for generating a document image on the basis of document data and displaying it on the screen 21, action sensors 24 for detecting an action (physical action) made by a user on the document display device 20, user ID input manipulation buttons 25 for receiving user identification information (user ID) from the user, location information manipulation buttons 26 for receiving information of a use location of the document display device 20 from the user, a correspondence information processing means 27 for storing information of a detected action and an input user ID and location information in such a manner that they are correlated with a document image being displayed on the screen 21, and a retrieving means 28 for retrieving document information corresponding to information of a detected action and an input user ID and location information from the document information storing means 22 by referring to the stored information of the correspondence information processing means 27.

Although in the above example action information, a user ID, location information, and document information are correlated with each other by using a document ID, action information, a user ID, location information, and document information may be correlated with each other directly.

Although in the above example action information, a user ID, and location information, another configuration is possible in which a user ID and location information are not used in addition to action information. As a further alternative, only one of a user ID and location information may be used.

FIG. 1 outlines how the document display device 20 operates. The operation of the document display device 20 will be described below with reference to FIGS. 1 and 2.

The document processing means 23 generates a document image on the basis of document information being held by the document information storing means 22, whereby the document image is displayed on the screen 21 of the document display device 20.

For example, if a user U makes an action (physical action) on the document display device 20 in a state that the document image (document A) is displayed on the screen 21 on the basis of the document information (electronic document data A) being held by the document information storing means 22, the action is detected by the sensors 24 and information of the detected action (e.g., acceleration movement information or posture information) is recorded so as to be correlated with the document information (electronic document data A) of the document being displayed on the screen 21 by the correspondence information processing means 27.

Therefore, if a user U makes an action on the document display device 20 in a state that a certain document is displayed on the screen 21, information of the action detected by the sensors 24 is recorded by the correspondence information processing means 27 so as to be correlated with the document information of the document being held by the document information storing means 22 via its document ID.

Where both of a user ID and location information are used, if a user ID and location information are input through the user ID input means 25 and the location information input means 26 in a state that a certain document is displayed on the screen 21, the user ID and the location information are recorded so as to be correlated with the document information of the document being held by the document information storing means 22 via its document ID.

If the user U makes a certain action (physical action) on the document display device 20 after switching from a recording mode, for example, to a retrieval mode in a state that the action information (and the user IDs and the location information) and the document information are correlated with each other in the above-described manner, the action is detected by the sensors 24. The retrieving means 28 retrieves document information corresponding to information of the detected action from the document information storing means 22 by referring to the recorded information of the correspondence information processing means 27. The display processing means 23 displays a document on the screen 21 on the basis of the retrieved document information.

Therefore, when a user makes an action on the document display device 20, document information correlated with action information that is approximately the same as information of the action just made is retrieved from the document information storing means 22 and the corresponding document image is displayed on the screen 21. That is, a document that was displayed on the screen 21 during action information correspondence recording can be displayed again on the screen 21 merely by the user's making, on the document display device 20, an action that is approximately the same as an action that was made during the correspondence recording.

Where a user ID and location information are also used, a user ID and location information are input when an action is made, whereby corresponding document information stored in the document information storing means 22 is retrieved and the document is displayed on the screen 21. Where a user ID is used in addition to action information in this manner, the document management can be performed on a user-by-user basis. Where location information is used, the document management can be performed on a location-by-location basis, for example, separately for the inside and outside of a company.

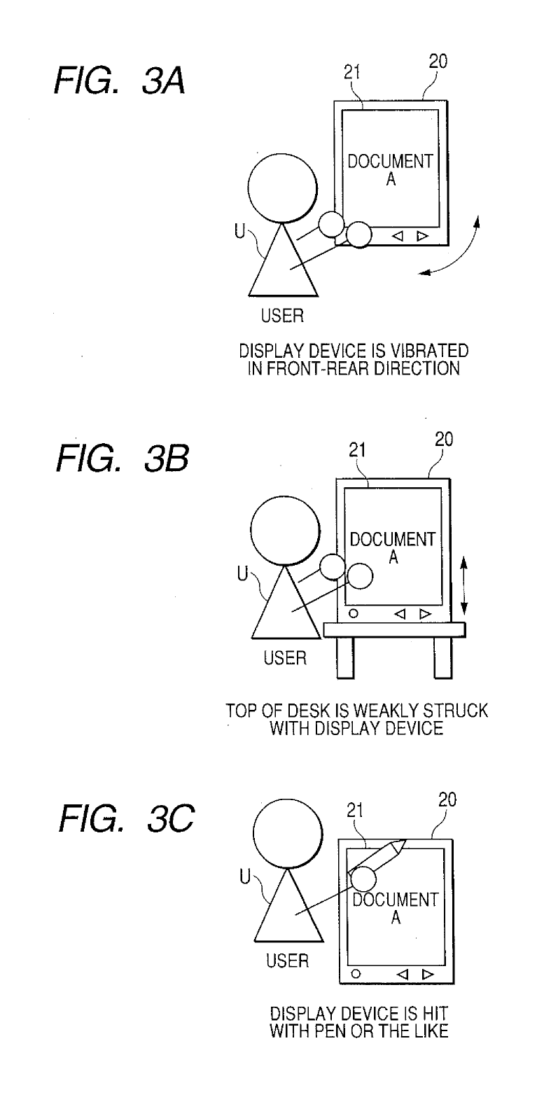

The above-described action information will be described below in more detail with reference to FIGS. 3-5.

A user U can make various kinds of actions such as rotation and swinging on the document display device 20. FIG. 3(a) shows an example in which the document display device 20 is vibrated in the front-rear direction, FIG. 3(b) shows an example in which vibration is given to the document display device 20 by weakly striking the top of a desk with the document display device 20, and FIG. 3(c) shows an example in which vibration is given to the document display device 20 by hitting the document display device 20 with a pen or the like.

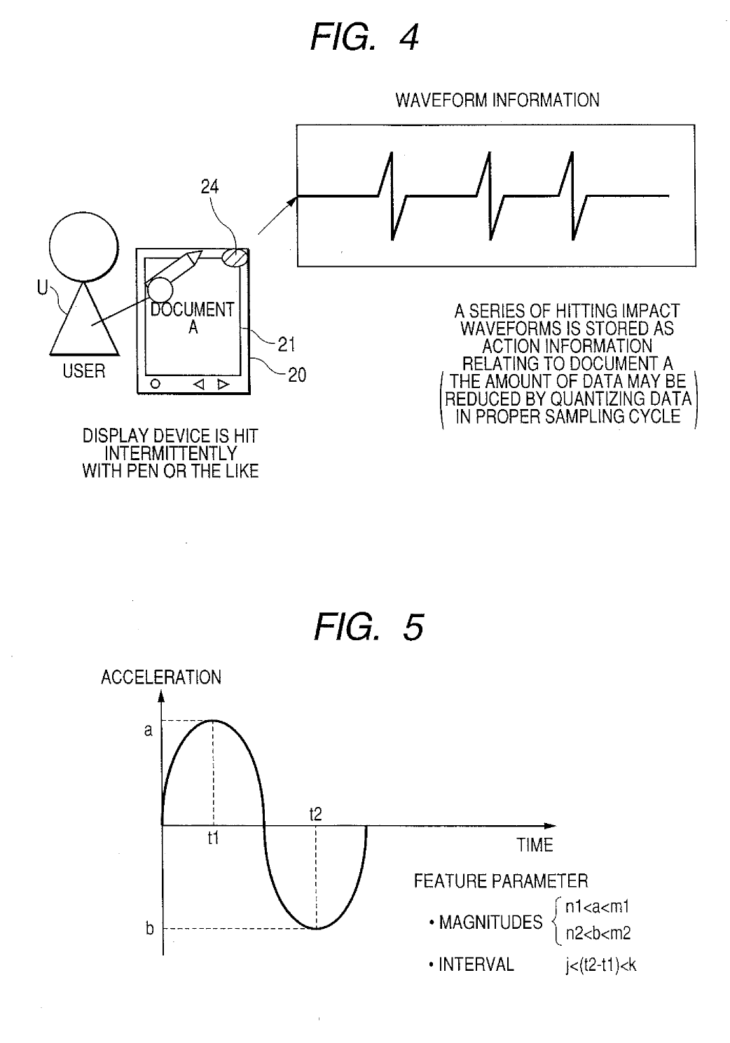

For example, when the document display device 20 is hit three times with a pen or the like, the acceleration sensor 24 detects the three hits and outputs waveform information having three hitting impact peaks as shown in FIG. 4.

The correspondence information processing means 27 records, as action information, the waveform information that is output from the sensor 24 in such a manner that it is correlated with document information. The retrieving means 28 can retrieve corresponding document information.

Since it is preferable that the amount of information to be stored and managed be as small as possible, it is preferable that waveform information that is output from the sensors 24 be used as action information after being quantized and compressed.

It is also preferable that waveform information is not used as action information as it is and, instead, the correspondence information processing means 27 and the retrieving means 28 extract feature parameters from the waveform and use the feature parameters as action information. For example, as shown in FIG. 5, it is preferable to extract feature parameters such as magnitudes of peaks (a, b) and peak interval (t2−t1) from acceleration waveform information that is output from the sensors 24 and to use the feature parameters as action information.

In practice, it is difficult to repeat exactly the same action. Therefore, an action made by a user at the time of retrieval may be approximately the same as an action made by the user during correspondence recording (i.e., an error within a certain range is allowable). Where waveform information is used, identity may be judged at the time of retrieval by setting a similarity range. Where feature parameters are used, identity may be judged at the time of retrieval by setting value ranges where actions are regarded as the same.

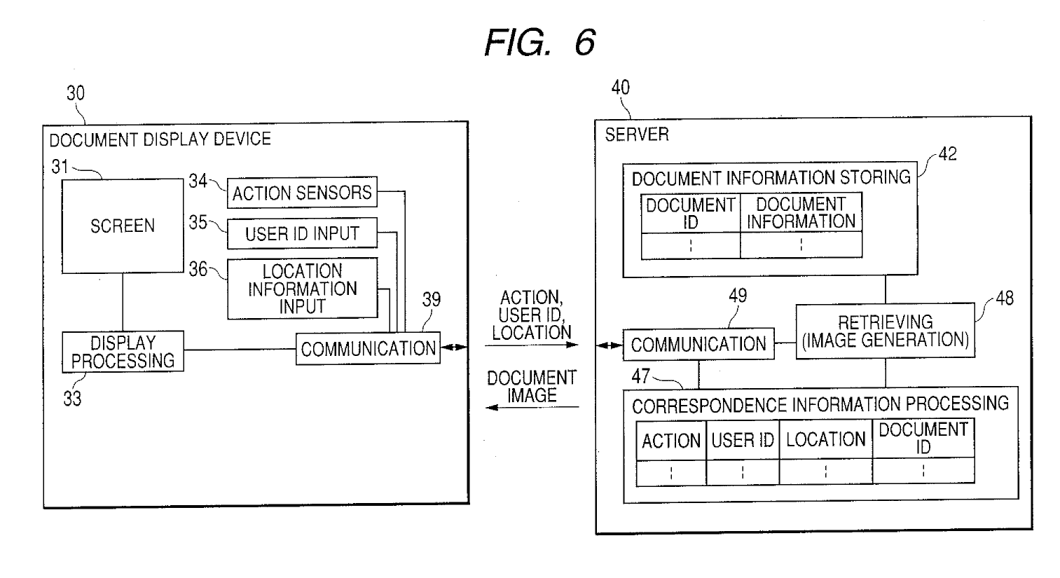

FIG. 6 shows an embodiment in which the invention is implemented as a document processing system that is composed of a document display device 30 for displaying a document image on the screen and a server 40 for managing document information.

This embodiment is of a thin client type in which the load of document display processing imposed on the document display device 30 is lowered, and is a system suitable for a case that the very fact that a document display device is configured so as to have a high processing ability like the above-described electronic paper EP makes its lightness and flexibility low.

The document display device 30 is equipped with a screen 31 for displaying a document image, a communication means 39 for communicating with the server 40 to exchange action information, document image information, etc., a display processing means 33 for displaying a document image received from the server 40 on the screen 31, action sensors 34 for detecting an action made by a user on the document display device 30, user ID input manipulation buttons 35 for receiving a user ID from the user, and location information manipulation buttons 36 for receiving information of a use location of the document display device 30 from the user.

The server 40 is equipped with a communication means 49 for communicating with the document display device 30 to exchange action information, document image information, etc., a document information storing means 42 for holding plural the document information that are discriminated from each other by respective document IDs, a correspondence information processing means 47 for recording action information, a user ID, and location information that are received from the document display device 30 in such a manner that they are correlated with corresponding document information recorded in the document information storing means 42 via its document ID, and a retrieving means 48 for retrieving document information corresponding to received action information, user ID, and location information from the document information storing means 42 by referring to the stored information of the correspondence information processing means 47, generating a document image from the retrieved document information, and causing the communication means 49 to transmit the document image to the document display device 30.

Although in the above example action information, a user ID, location information, and document information are correlated with each other by using a document ID, action information, a user ID, location information, and document information may be correlated with each other directly.

The above functional means necessary for the processing of the invention can be realized in such a manner that the computer hardware of the document display device 30 and the server 40 runs programs relating to the invention.

In the above document processing system, first, the document display device 30 receives certain document image data from the server 40 in response to, for example, a user U's manipulating the server 40 or the user U's sending a request including document designation information to the server 40 by manipulating the document display device 40, and the display processing means 33 displays the document image on the screen 31.

That is, in the server 40, the retrieving means 48 reads corresponding document information from the document information storing means 42 and generates a document image in response to a request received from the document display device 30 and the communication means 49 transmits the generated document image to the request source document display device 30. The correspondence information processing means 47 records a document ID corresponding to the document image that is transmitted to the document display device 30.

If the user U makes an action on the document display device 30 in a state that the document image (document A) is displayed on the screen 31, the action is detected by the sensors 34 and the communication means 39 transmits information of the detected action to the server 40.

In the server 40, the communication means 49 receives the action information from the document display device 30 and the correspondence information processing means 47 records the received action information in such a manner that it is correlated with the document ID previously recorded by the correspondence information processing means 47 (i.e., the document ID of the document A that was supplied to the document display device 30 and is now being displayed on its screen 31).

Therefore, when a user makes an action on the document display device 30 in a state that a certain document is displayed on the screen 31, in the server 40, the correspondence information processing means 47 records information of the action detected by the sensors 34 in such a manner that it is correlated with document information of the document held by the document information storing means 42.

Where a user ID and location information are also used, if a user ID and location information are input in a state that a certain document is displayed on the screen 31, the user ID and the location information are transmitted to the server 40 and are recorded so as to be correlated with document information of the document held by the document information storing means 42.

If the user U makes a certain action on the document display device 30 in a state that the action information (and the user IDs and the location information) and the document information are correlated with each other, the action is detected by the sensors 34 and information of the detected action is transmitted to the server 40 by the communication means 39.

In the server 40, when the communication means 49 receives the action information, the retrieving means 48 retrieves document information corresponding to the received action information from the document information storing means 42 by referring to the recorded information of the correspondence information processing means 47 and generates a document image on the basis of the retrieved document information. The communication means 49 transmits the generated document image to the request source document display device 30.

In the request source document display device 30, the communication means 39 receives the document image from the server 40 and the display processing means 33 displays the received document image on the screen 31.

Therefore, when a user makes an action on the document display device 30, document information correlated with action information that is approximately the same as information of the action just made is retrieved in the server 40 and the corresponding document image is supplied from the server 40 to the document display device 30 and displayed on the screen 31. That is, a document that was displayed on the screen 31 during action information correspondence recording can be displayed again on the screen 31 merely by the user's making, on the document display device 30, an action that is approximately the same as an action that was made during the correspondence recording.

Where a user ID and location information are also used, a user ID and location information are input through the user ID input means 35 and the location information input means 36 when an action is made. And the user ID and the location information are transmitted to the server 40 like action information. At the time of recording, the correspondence information processing means 47 records the user ID and the location information together with the action information in such a manner that they are correlated with corresponding document information. At the time of retrieval, the retrieving means 48 retrieves the corresponding document information and the corresponding document image is supplied to the document display device 30 and displayed on the screen 31.

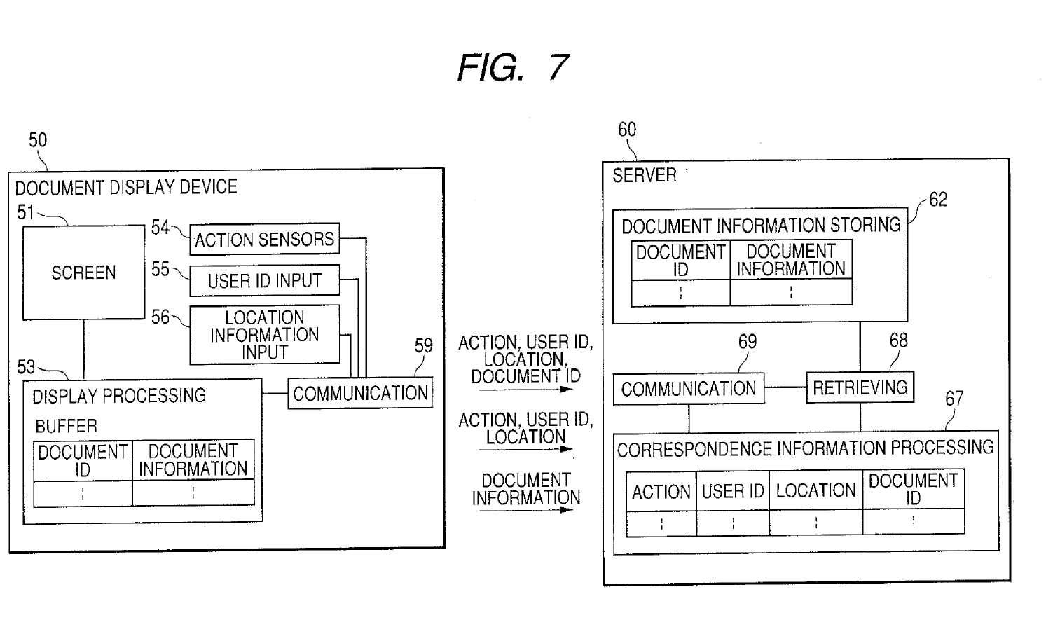

FIG. 7 shows an embodiment in which the invention is implemented as a document processing system that is composed of a document display device 50 for displaying a document image on the screen and a server 60 for managing document information.

This embodiment is of a type in which the document display device 50 has a certain level of document display ability. The document display device 50 holds plural the document information and the document image displayed on the screen 51 can be switched.

The document display device 50 is equipped with the screen 51 for displaying a document image, a communication means 59 for communicating with the server 60 to exchange action information, document information, etc., a display processing means 53 for generating a document image on the basis of document information received from the server 60 and displaying the generated document image on the screen 51, action sensors 54 for detecting an action made by a user on the document display device 50, user ID input manipulation buttons 55 for receiving a user ID from the user, and location information manipulation buttons 56 for receiving information of a use location of the document display device 50 from the user.

The server 50 is equipped with a communication means 69 for communicating with the document display device 50 to exchange action information, document information, etc., a document information storing means 62 for holding plural the document information that are discriminated from each other by respective document IDs, a correspondence information processing means 67 for recording action information, a user ID, and location information that are received from the document display device 50 in such a manner that they are correlated with corresponding document information recorded in the document information storing means 62 via its document ID, and a retrieving means 68 for retrieving document information corresponding to received action information, user ID, and location information from the document information storing means 62 by referring to the stored information of the correspondence information processing means 67 and causing the communication means 49 to transmit the retrieved document information to the document display device 50.

Although in the above example action information, a user ID, location information, and document information are correlated with each other by using a document ID, action information, a user ID, location information, and document information may be correlated with each other directly.

The above functional means necessary for the processing of the invention can be realized in such a manner that the computer hardware of the document display device 50 and the server 60 runs programs relating to the invention.

In the above document processing system, first, the document display device 50 receives one or plural the document information accompanied by respective document IDs from the server 60 in response to, for example, a user U's manipulating the server 60 or the user U's sending a request including document designation information to the server 60 by manipulating the document display device 50. The display processing means 53 holds the one or plural the document information, generates a document image on the basis of the one piece of document information or one of the plural the document information, and displays the document image on the screen 31.

That is, in the server 60, the retrieving means 48 reads corresponding document information and document IDs from the document information storing means 62 in response to a request received from the document display device 50 and the communication means 69 transmits the read-out document information and document IDs to the request source document display device 50.

If the user U makes an action on the document display device 50 in a state that the document image (document A) is displayed on the screen 51, the action is detected by the sensors 54 and the communication means 59 transmits information of the detected action and the document ID of the document being displayed on the screen 51 to the server 60.

In the server 60, the communication means 69 receives the action information and the document ID from the document display device 50 and the correspondence information processing means 67 records the received action information in such a manner that it is correlated with the document ID (i.e., the document ID of the document A that was supplied to the document display device 50).

Therefore, when a user makes an action on the document display device 50 in a state that a certain document is displayed on the screen 51, in the server 60, the correspondence information processing means 67 records information of the action detected by the sensors 54 in such a manner that it is correlated with document information of the document held by the document information storing means 62.

where a user ID and location information are also used, if a user ID and location information are input in a state that a certain document is displayed on the screen 51, the user ID and the location information are transmitted to the server 60 and are recorded so as to be correlated with document information of the document held by the document information storing means 62.

If the user U makes a certain action on the document display device 30 in a state that the action information (and user IDs and location information) and the document information are correlated with each other, the action is detected by the sensors 54 and information of the detected action is transmitted to the server 60 by the communication means 59.

In the server 60, when the communication means 69 receives the action information, the retrieving means 68 retrieves document information corresponding to the received action information from the document information storing means 62 by referring to the recorded information of the correspondence information processing means 67 and the communication means 69 transmits the retrieved document information to the request source document display device 50.

In the request source document display device 50, the communication means 59 receives the document information from the server 60 and the display processing means 53 displays a document image on the screen 51 on the basis of the received document information.

Therefore, when a user makes an action on the document display device 50, document information correlated with action information that is approximately the same as information of the action just made is retrieved in the server 60 and the document information is supplied from the server 60 to the document display device 50 and displayed on the screen 51. That is, a document that was displayed on the screen 51 during action information correspondence recording can be displayed again on the screen 51 merely by the user's making, on the document display device 50, an action that is approximately the same as an action that was made during the correspondence recording.

Where a user ID and location information are also used, a user ID and location information are input through the user ID input means 55 and the location information input means 56 when an action is made. And the user ID and the location information are transmitted to the server 60 like action information. At the time of recording, the correspondence information processing means 67 records the user ID and the location information together with the action information in such a manner that they are correlated with corresponding document information. At the time of retrieval, the retrieving means 68 retrieves the corresponding document information and the corresponding document information is supplied to the document display device 30 and displayed on the screen 51.

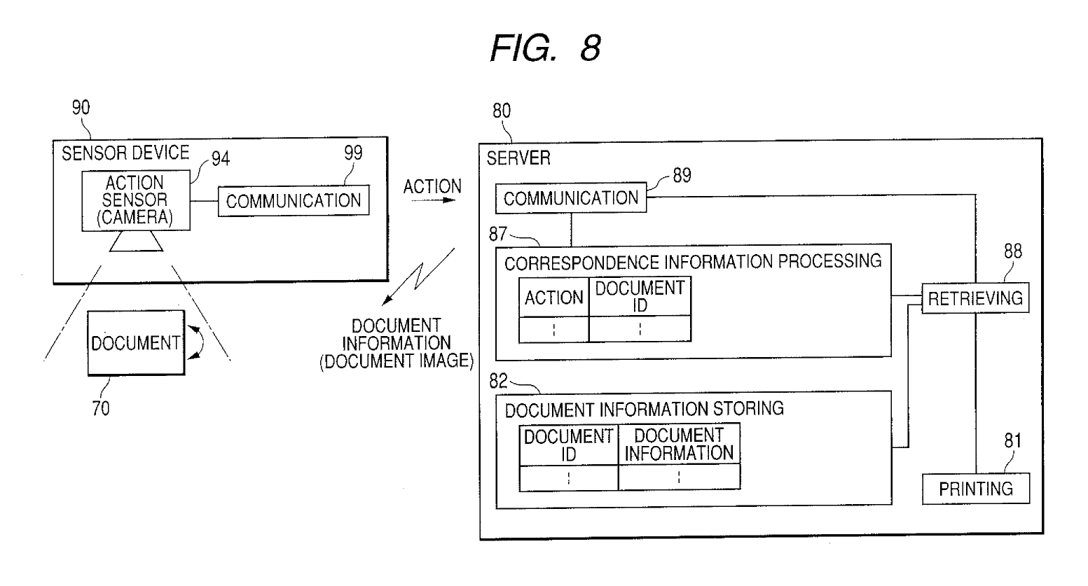

FIG. 8 shows an embodiment in which the invention is implemented as a document processing system that is composed of a document display unit 70 for continuing to display a document image, a server 80 for managing document information, and a sensor device 90 for detecting an action made on the document display unit 70.

In this embodiment, the document display unit 70 may be a printed material on which a document image is printed in addition to the above-described document display device. For example, an action made on the printed material 70 by a user can be detected by the sensor device 90 and recorded so as to be correlated with corresponding document information. Further, the server 80 can print-output a corresponding document on the basis of document information corresponding to an action detected by the sensor device 90.

The server 80 is equipped with a communication means 89 for communicating with the sensor device 90 (and the document display unit that is the above-described document display device) to exchange action information, document image information, etc., a document information storing means 82 for holding plural the document information that are discriminated from each other by respective document IDs, a correspondence information processing means 87 for recording action information that is received from the sensor device 90 in such a manner that it is correlated with corresponding document information recorded in the document information storing means 82 via its document ID, a retrieving means 88 for retrieving document information corresponding to received action information from the document information storing means 82 by referring to the stored information of the correspondence information processing means 87, and printing means 81 for print-outputting the document on the basis of the retrieved document information.

The communication means 89 transmits the retrieved document information to the document display unit that is the above-described document display device.

The sensor device 90 is equipped with an action sensor 94 for detecting an action made on the document display unit 70 and a communication means 99 for transmitting information of the detected action to the server 80.

The action sensor 94 of this embodiment is a video camera for shooting the document display unit 70. The sensor device 90 transmits, to the server 80, action information obtained by analyzing a video image taken by the sensor device 90.

It can be said that the above-described document display device is a document display unit having the document image display maintaining function of a printed material and the action detecting function of the sensor device 90.

In the above document processing system, first, the server 80 recognizes, in advance, a document ID of a document image that continues to be displayed on the document display unit 70. A user U makes an action on the document display unit 70 in a state that the document image is displayed thereon. The sensor device 90 shoots the document display unit 70, detects the action, and transmits information of the detected action to the server 80 by means of the communication means 99.

In the server 80, the communication means 89 receives the action information from the sensor device 90 and the correspondence information processing means 87 records the received action information in such a manner that it is correlated with the document ID (i.e., the previously recognized document ID).

Therefore, when a user makes an action on the document display unit 70 on which a certain document is being displayed, in the server 80, the correspondence information processing means 87 records information of the action detected by the sensor device 90 in such a manner that it is correlated with document information of the document held by the document information storing means 82.

Where a user ID and location information are also used, if a user ID and location information are input, the user ID and the location information are transmitted from the sensor device 90 to the server 80 and are recorded so as to be correlated with document information of the document held by the document information storing means 82.

If the user U makes a certain action on the document display unit 70 in a state that the action information (and the user IDS and the location information) and the document information are correlated with each other in the above-described manner, the action is detected by the sensor device 90 and information of the detected action is transmitted to the server 80 by the communication means 99.

In the server 80, when the communication means 89 receives the action information, the retrieving means 88 retrieves document information corresponding to the received action information from the document information storing means 82 by referring to the recorded information of the correspondence information processing means 87 and the communication means 89 transmits the retrieved document information to the request source document display unit (document display device) 70 to allow its display on the screen. Alternatively, the printing means 81 print-outputs the document on the basis of the retrieved document information.

Therefore, when a user makes an action on the document display unit 70, document information correlated with action information that is approximately the same as information of the action just made is retrieved in the server 80 and the document information is supplied from the server 80 to the document display unit 70 and displayed on the screen. Alternatively, a printed material is output on the basis of the document information. That is, a document that was displayed during action information correspondence recording can be displayed again merely by the user's making, on the document display unit 70, an action that is approximately the same as an action that was made during the correspondence recording.

Where a user ID and location information are also used, at the time of retrieval, the retrieving means 88 retrieves corresponding document information.

As described above, according to the invention, a corresponding document is displayed again in response to an action made on the document display device by a user. However, there may occur an event that plural documents are retrieved in response to a certain action. An appropriate operation to be performed in such a case is to supply the plural retrieved candidates (document images or document information) to the document display device and display those candidate documents on the screen as thumbnail images to allow the user to select one of those.

What is claimed is:

1. A document processing system having a document display unit for continuing to display a document image, a sensor device for detecting an action made on the document display unit, and a server for managing document information, wherein:
the sensor device includes:
a sensor for detecting an action made on the document display unit that continues to display a document image; and
a communication means for transmitting information of the action detected by the sensor to the server; and
the server includes:
a document information storing means for holding the document information;
a correspondence information processing means for storing action information received from the sensor device in such a manner that it is correlated with document information of a document image continuing to be displayed on the document display unit; and
a communication means for receiving the action information from the sensor device.

2. A document processing system having a document display unit for continuing to display a document image, a sensor device for detecting an action made on the document display unit, and a server for managing document information, characterized in:
the sensor device includes:
a sensor for detecting an action made on the document display unit that continues to display a document image; and
a communication means for transmitting information of the action detected by the sensor to the server; and
the server includes:
a document information storing means for holding the document information;
a correspondence information processing means for holding action information that are correlated with respective piece of document information;
a communication means for receiving the action information from the sensor device; and
a retrieving means for retrieving document information corresponding to information of an action detected by the sensor device from the document information storing means by referring to the correspondence information processing means.

3. A document processing system having a document display device for displaying a document image on a screen on the basis of document information and a server for managing document information, wherein:
the document display device includes:
the screen for displaying a document image received from the server;
a sensor for detecting an action made on the document display device in a state that the document image is displayed on the screen; and
a communication means for receiving the document image from the server and for transmitting information of the action detected by the sensor to the server; and
the server includes:
a document information storing means for holding the document information;
an image generating means for generating a document image on the basis of document information;
a correspondence information processing means for storing action information received from the document display device in such a manner that it is correlated with document information of a document image being displayed on the screen of the document display device; and
a communication means for receiving the action information from the document display device and for transmitting the document image to the document display device.

4. A document processing system having a document display device for displaying a document image on a screen on the basis of document information and a server for managing the document information, wherein:
the document display device includes:
the screen for displaying a document image received from the server;
a sensor for detecting an action made on the document display device; and
a communication means for receiving the document image from the server and for transmitting information of the action detected by the sensor to the server; and
the server comprises:
a document information storing means for holding the document information;
an image generating means for generating a document image on the basis of document information;
a correspondence information processing means for holding action information that are correlated with respective the document information;
a retrieving means for retrieving document information corresponding to action information received from the document display device from the document information storing means by referring to the correspondence information processing means;
an image generating means for generating a document image on the basis of the retrieved document information; and
a communication means for receiving the action information from the document display device and for transmitting the generated document image to the document display device.

5. A document processing system having a document display device for displaying a document image on a screen on the basis of document information and a server for managing document information, wherein:
the document display device comprises:
a sensor for detecting an action made on the document display device;
a document information storing means for holding the document information of documents to be displayed on the screen; and
a communication means for transmitting, to the server, information of the action detected by the sensor in a state that a document image is displayed on the screen and identification information of the document information; and
the server comprises:
a document information storing means for holding the document information;
a correspondence information processing means for storing action information received from the document display device in such a manner that it is correlated with document information of a document image being displayed on the screen of the document display device; and
a communication means for receiving the action information and the document identification information from the document display device.

6. A document processing system having a document display device for displaying a document image on a screen on the basis of document information and a server for managing document information, wherein:
the document display device comprises:
a display processing means for displaying a document image on the screen on the basis of document information received from the server;
a sensor for detecting an action made on the document display device; and
a communication means for receiving the document image from the server and for transmitting information of the action detected by the sensor to the server; and
the server comprises:
a document information storing means for holding the document information;
a correspondence information processing means for holding action information that are correlated with respective the document information;
a retrieving means for retrieving document information corresponding to action information received from the document display device from the document information storing means by referring to the correspondence information processing means; and
a communication means for receiving the action information from the document display device and for transmitting the retrieved document information to the document display device.

7. The document processing system according to claim 3, wherein:
the document display device further comprises user information input means through which to input user identification information;
the communication means transmits the input user identification information to the server; and
the correspondence information processing means stores the received user identification information and the action information in such a manner that they are correlated with the document information.

8. The document processing system according to claim 4, wherein:
the document display device further comprises user information input means through which to input user identification information;
the communication means transmits the input user identification information to the server;
the correspondence information processing means holds the received user identification information and the action information in such a manner that they are correlated with respective document information; and
the retrieving means retrieves document information corresponding to received action information and user identification information from the document information storing means by referring to the correspondence information processing means.

9. The document processing system according to claim 3, wherein:
the document display device further comprises location information input means through which to input information of a location where the document display device exists;
the communication means transmits the input location information to the server; and
the correspondence information processing means stores the received location information and the action information in such a manner that they are correlated with the document information.

10. The document processing system according to claim 4, wherein:
the document display device further comprises location information input means through which to input information of a location where the document display device exists;
the communication means transmits the input location information to the server;
the correspondence information processing means holds received location information and the action information in such a manner that they are correlated with respective document information; and
the retrieving means retrieves document information corresponding to received action information and location information from the document information storing means by referring to the correspondence information processing means.

11. The document processing system according to claim 3, wherein
the document display device is a flexible, thin electronic paper having a display section for continuing to display a document image in a state that it is not supplied with electric power.

12. A document processing method executed by a document display device for displaying a document image on a screen on the basis of document information and a server for managing the document information, comprising:
the document display device's displaying a document image received from the server, detecting an action made on the document display device itself in a state that the document image is displayed on the screen, and transmitting information of the detected action to the server; and
the server's storing the action information received from the document display device in such a manner that it is correlated with document information of the document image being displayed on the screen of the document display device.

13. A document processing method executed by a document display device for displaying a document image on a screen on the basis of document information and a server for managing the document information, comprising:
the document display device's detecting an action made on the document display device itself and transmitting information of the detected action to the server;
the server's retrieving document information corresponding to the action information received from the document display device by referring to correspondence information that correlates action information with respective the document information, generating a document image on the basis of the retrieved document information, and transmitting the generated document image to the document display device; and
the document display device's displaying the document image received from the server on the screen.

14. A document processing method executed by a document display device for displaying a document image on a screen on the basis of document information and a server for managing the document information, comprising:
the document display device's detecting an action made on the document display device itself in a state that a document image is displayed on the screen on the basis of document information, and transmitting information of the detected action and identification information of the document information to the server; and
the server's storing the action information received from the document display device in such a manner that it is correlated with the document information of the document image being displayed on the screen of the document display device.

15. A document processing method executed by a document display device for displaying a document image on a screen on the basis of document information and a server for managing the document information, comprising:
the document display device's detecting an action made on the document display device itself and transmitting information of the detected action to the server;
the server's retrieving document information corresponding to the action information received from the document display device by referring to correspondence information that correlates action information with respective the document information, and transmitting the retrieved document information to the document display device; and
the document display device's displaying a document image on the screen on the basis of the document information received from the server.
